(19) United States
(12) Patent Application Publication
(10) Pub. No.: US 2011/0224941 A1
(43) Pub. Date: Sep. 15, 2011

(54) Compact Motion Powered Thermometer

(75) Inventor: Chu-Yih Yu, Taipei Hsien (TW)

(73) Assignee: MESURE TECHNOLOGY CO., LTD., San Chung City (TW)

(21) Appl. No.: 12/985,496

(22) Filed: Jan. 6, 2011

(30) Foreign Application Priority Data
Mar. 9, 2010 (TW) 099204190
Nov. 17, 2010 (TW) 099222332

(51) Int. Cl. G06F 15/00

(52) U.S. Cl. 702/130

(57) ABSTRACT

A compact motion powered thermometer includes a body member and a tip member with a thermal contact surface secured to the body member. A thermal sensor mounted on the inside of the tip member is adapted for sensing a thermal contact surface and producing a temperature signal. A set of lead wires is coupled to the thermal sensor for transmission of the temperature signal. A display module is disposed in the body member. A motion electric power generator supplies a power to a capacitor. A processor is electrically connected to both the capacitor to obtain electric power and the set of lead wires to receive the temperature signal such that it can drive the display module for display of a corresponding temperature reading. The display module, the processor and the capacitor are disposed on a substrate. The substrate, the tubular cylinder and the body member are parallel to each other.

### BACKGROUND OF THE INVENTION

1. Field of the Invention

The invention relates to the field of thermometers, and more particularly to the field of compact motion powered thermometers.

2. Description of the Related Art

Electronic thermometers generally offer a great number of advantages over conventional glass and mercury thermometers for use in the health care field. Among the advantages of electronic thermometers are the elimination of sterilization procedures for glass thermometers, made possible by the use of disposable covers; elimination of the possibility of broken glass if a thermometer is dropped; a digital temperature display to eliminate temperature reading errors; and with proper circuit design and calibration, higher accuracy and resolution is possible with accurate measurement and display of tenths of a degree Fahrenheit being easily attainable.

Such electronic thermometers typically use a chemical battery as a power supply. However, the electronic thermometers are generally idle for a long time since patients only use the electronic thermometers while they are sick or feel uncomfortable. Thus such electronic thermometers employing a chemical battery as a power supply are not environmentally friendly.

### SUMMARY OF THE INVENTION

An exemplary embodiment of the present invention overcomes the above-described problems by providing a compact motion powered thermometer includes a body member and a tip member with a thermal contact surface secured to the body member. A thermal sensor mounted on the inside of the tip member is adapted for sensing a thermal contact surface and producing a temperature signal. A set of lead wires is coupled to the thermal sensor for transmission of the temperature signal. A display module is disposed in the body member. A motion electric power generator supplies a power to a capacitor. A processor is electrically connected to both the capacitor to obtain electric power and the set of lead wires to receive the temperature signal such that it can drive the display module for display of a corresponding temperature reading. The display module, the processor and the capacitor are disposed on a substrate. The substrate, the tubular cylinder and the body member are parallel to each other.

### DESCRIPTION OF THE DRAWINGS

The present invention will be described by way of exemplary embodiments, but not limitations, illustrated in the accompanying drawings in which like references denote similar elements, and in which:

FIG. 1 is a schematic view of a motion powered thermometer according to an exemplary embodiment of the invention; and

FIG. 2 is an exploded perspective view of the motion powered thermometer of FIG. 1;

FIG. 3 is a schematic view of a motion electric power generator according to an exemplary embodiment of the invention;

FIG. 4 is a schematic view of a tubular cylinder and support portions according to an exemplary embodiment of the invention;

FIG. 5A is a schematic view of an inner opening of the support portion of FIG. 4; and

FIG. 5B is a schematic view of an outer opening of the support portion of FIG. 4.

### DETAILED DESCRIPTION OF THE INVENTION

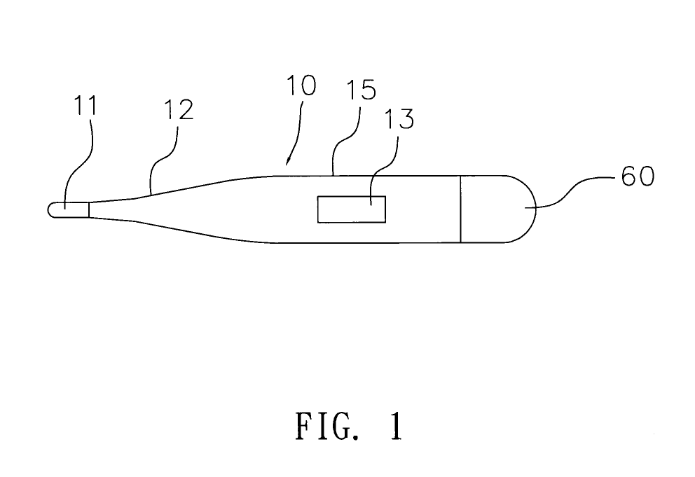

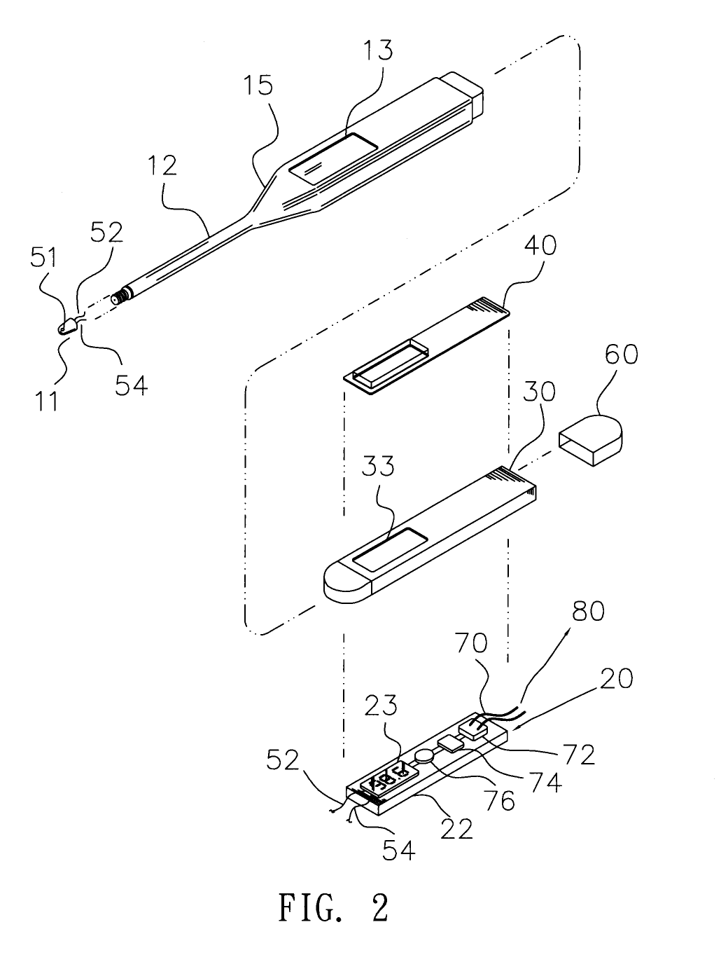

Referring to FIGS. 1 and 2, an embodiment of a thermometer is illustrated. The thermometer is made up of a body member 10 and a tip member 11. Typically, a cover 60 is secured to body member 10 after components of the thermometer have been assembled. Body member 10 includes a probe portion 12 and a display portion 15. Tip member 11 is secured to probe portion 12 of body member 10. Preferably, it contains a thermal contact surface surrounding a hollow cavity. In one embodiment, hollow tip member 11 is preferably made of metal with good thermal conductivity, such as stainless steel.

A thermal sensor 51 is placed at the end of tip member 11 and mounted on the inside of the thermal contact surface. Thermal sensor 51 senses the temperature of the thermal contact surface and produces a temperature signal. There are a set of lead wires 52 and 54 coupled to thermal sensor 51 for transmission of the temperature signal.

As shown in FIG. 2, a display module 20 is disposed in display portion 15 and connected to lead wires 52 and 54 to receive the temperature signal for display of a corresponding temperature reading. Although optional, a base plate 30 may be used to cover display module 20. In one example, display module 20 may comprise a substrate 22 to support a display panel 23, such as LCD panel, disposed thereon. A processor 76, such as integrated circuit chip, is disposed on substrate 20 to be coupled to digital display 23. Processor 76 is electrically connected to lead wires 52 and 54 to receive the temperature signal; it drives display panel 23 to show a corresponding temperature reading. Preferably, base plate 30 has an opening 33 to expose display panel 23. Typically, base plate 30 is made from a plastic material and substrate 22 is a PCB board.

In one example, tip member 11 is made in the form of a tubular shape and closed at a domed, hemispherical or hemiellipsoid shaped end. The contact surface is brought in contact with flesh of a patient so that heat can be transferred from the patient's flesh to tip member 11. In one embodiment, thermal sensor 51 is thermistor. Lead wires 52 and 54 and thermistor 51 are both adhered on the inside of the thermal contact surface with heat conductive glue. The glue is an insulating material with good thermal conductivity, e.g., epoxy resin. Moreover, lead wires 52 and 54 are made up of a pair of electrical lead wires; they are used to connect thermal sensor 51 to processor 76 for determining a corresponding temperature to display.

A transparent layer 40 extending from an upper surface thereof at least covers display module 20 under a display aperture 13. Preferably, transparent layer 40 covers an entire upper surface of base plate 30. And generally, digital display 23 is disposed on substrate 22 and under transparent layer 40. Transparent layer 40 may be a transparent plastic sheet. Preferably, the transparent layer is made of organic glass or polymethyl methacrylate(PMMA).

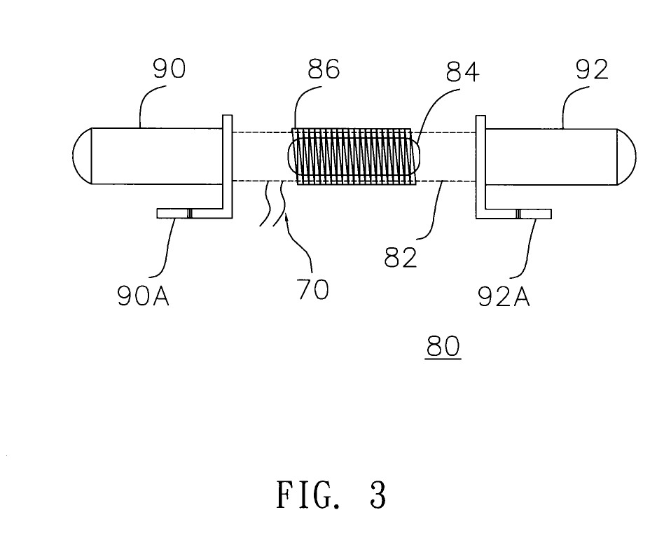

Adverting to FIG. 3, a motion electric power generator 80 disposed in body member 10, is parallel to substrate 22 of display module 20. Motion electric power generator 80 comprises a tubular cylinder 82 disposed in body member 10 and a magnetic core 84 being free to slide within tubular cylinder 82. Tubular cylinder 82 may be made of transparent material. A coil of wire 86 is wrapped around tubular cylinder 82 so that magnetic core 84 moves through the coil of wire 86 when sliding through tubular cylinder 82 from one end to an opposite end. As shown in FIG. 2 and FIG. 3, an electromotive force is generated by the coil of wire 86, so that an AC power is output. In addition, the AC power output is rectified by a rectifier 72 to supply the power to a capacitor 74, such as chip capacitor, through the electricity transmission wires 70. As magnetic core 84 moves through tubular cylinder 82 back and forth, it will change the magnet flux flowing through the coil of wire 86, increasing the capacity.

Further, processor 76 is electrically connected to both capacitor 74 to obtain electric power and the set of lead wires 52 and 54 to receive the temperature signal such that it can drive display panel 23 for display of a corresponding temperature reading. In one example, capacitor 74 stores electrical energy by continuously moving the thermometer back and forth. Processor 76 is actuated to generate voice through a speaker to inform the user or drive display panel 23 to display a starting signal showing a status that the thermometer starts to perform a charging action, while the charged capacitor voltage is increased to at least a predetermined start voltage. After that, processor 76 is continuously detecting a change of the capacitor voltage. During a short motion time, Processor 76 is actuated to generate voice through a speaker to inform the user or drive display panel 23 to display an operation signal showing a status that the thermometer is ready to perform a body temperature measuring operation action, while the charged capacitor voltage is further increased to at least a predetermined operation voltage, higher than the predetermined start voltage, which is enough to perform at least one or two cycles of body temperature measuring operation. Specifically, the aforementioned functions can be integrated in one or several chips.

In such thermometers, capacitor stores energy for the processor to use on demand, so it can be used like a temporary battery to maintain power supply. Thus, there is no need to use a chemical battery which is easy to cause environmental pollution.

In addition, display panel 23, processor 76 and capacitor 74 are disposed on substrate 22. Tubular cylinder 82, substrate 22 and display portion 15 are parallel to each other. Specifically, tubular cylinder 82 is disposed under substrate 22.

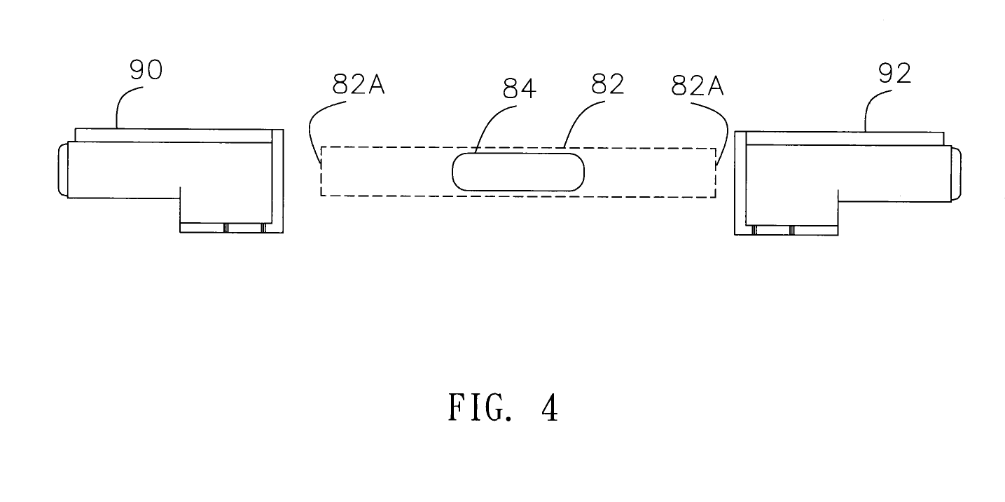

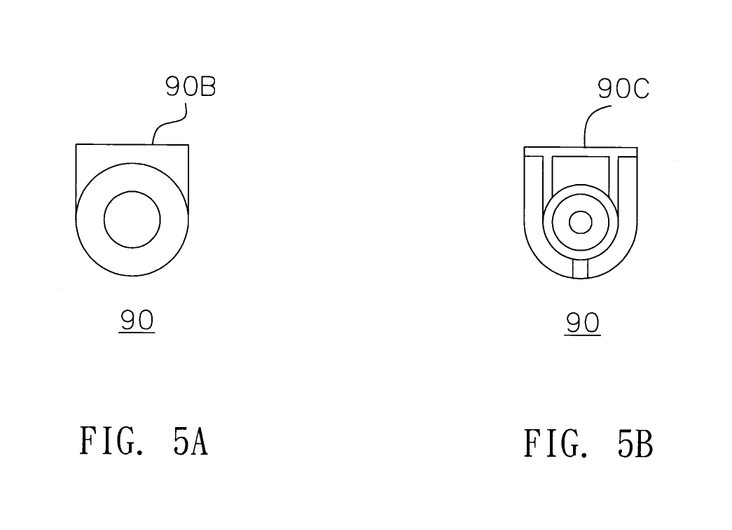

As shown in FIGS. 4, 5A and 5B, a schematic view of a tubular cylinder 82 and support portions 90 and 92 according to an exemplary embodiment is illustrated. For example, motion electric powered generator 80 comprises a pair of support portions 90 and 92 respectively having an inner opening 90B communicated with an outer opening 90C. In this case, two end portions of tubular cylinder 82 each comprising a vent hole 82A, may be dimensioned and configured to permit insertion into the pair of inner openings 90B of support portions 90 and 92 in a fixed or detachable form. Thus, vent holes 82A are communicated with outer openings 90C through inner openings 90B, so that air resistance within tubular cylinder 82 can be lowered when the magnetic core 84 moves through tubular cylinder 82 back and forth. Specifically, the size of magnetic core 84 or inner openings 90B is larger than that of outer openings 90C to avoid the magnetic core 84 moving out of tubular cylinder 82. In other words, the pair of support portions 90, 92 each serves as a stop of magnetic core 84. In a preferred embodiment, the pair of support portions 90, 92 each comprises a platform 90A and 92A thereon to securely support a bottom surface of substrate 22.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A motion powered thermometer comprising:
a body member and a tip member with a thermal contact surface secured to the body member;
a thermal sensor mounted on the inside of the tip member, adapted for sensing the thermal contact surface and producing a temperature signal;
a set of lead wires, coupled to the thermal sensor for transmission of the temperature signal;
a motion electric power generator comprising:
a tubular cylinder, disposed in the body member,
a magnetic core, being free to slide within the tubular cylinder,
a coil of wire, wrapped around the tubular cylinder so that the magnetic core moves through the coil of wire when sliding through the tubular cylinder from one end to an opposite end, and
a capacitor, electrically connected to the coil of wire;
a display module, disposed in the body member;
a processor, electrically connected to both of the capacitor to obtain electric power and the set of lead wires to receive the temperature signal, driving the display module for display of a corresponding temperature reading; and
a substrate disposed in the body member and the display module, the processor and the capacitor thereon, wherein the substrate, the tubular cylinder and the body member are parallel to each other.

2. The thermometer as recited in claim 1 wherein the tubular cylinder is disposed under the substrate.

3. The thermometer as recited in claim 2 further comprising a pair of support portions on both ends of the tubular cylinder.

4. The thermometer as recited in claim 3 wherein the pair of support portions comprises respective platform member with a flat surface to support the substrate.

5. The thermometer as recited in claim 1 further comprising a pair of vent holes on both ends of the tubular cylinder.

6. The thermometer as recited in claim 5, further comprising a pair of support portions having respective inner openings and respective outer openings communicated with the inner openings, wherein the both ends of the tubular cylinder are dimensioned and configured to permit insertion into the pair of inner openings.

7. The thermometer as recited in claim 6, wherein both of the pair of vent holes of the tubular cylinder are communicated with the outer openings through the inner openings.

8. The thermometer as recited in claim 7, wherein the size of the outer opening is smaller than that one of the magnetic core, to avoid the magnetic core moving out of the support portion.

9. The thermometer as recited in claim 8, wherein the size of the outer opening is smaller than that one of the inner opening.

10. The thermometer as recited in claim 9, wherein tubular cylinder are transparent.

11. The thermometer as recited in claim 9 wherein the tubular cylinder is disposed under the substrate.

12. The thermometer as recited in claim 11 wherein the pair of support portions comprises respective platform member with a flat surface to support the substrate.
